(19) United States
(12) Patent Application Publication
(10) Pub. No.: US 2005/0012676 A1
(43) Pub. Date: Jan. 20, 2005

(54) N-port signal divider/combiner

(76) Inventors: Robert Daniel McCarthy, Newbury Park, CA (US); Amedeo A. Mazzilli, Castail, CA (US)

Correspondence Address: WELSH & KATZ, LTD, 120 S RIVERSIDE PLAZA, 22ND FLOOR, CHICAGO, IL, 60606, US

(21) Appl. No.: 10/620,507

(22) Filed: Jul. 16, 2003

(51) Int. Cl. H01P 5/12; H01Q 21/00

(52) U.S. Cl. 343/853; 333/134

(57) ABSTRACT

An N-port signal divider/combiner for dividing and/or combining signals in N−1 frequency bands, including a common line; and N−1 signal ports each coupled to the common line by a respective transmission line, each transmission line having one or more stubs extending from the transmission line, each stub having a length selected so that the stub acts as a notch filter at a respective rejection wavelength, wherein at least one of the stubs is a short-circuit stub, and at least one of the stubs is an open-circuit stub. A first one of the stubs has a length nλ₁/4 selected so that the stub acts as a notch filter at a first rejection wavelength λ₁, a second one of the stubs has a length mλ₂/4 selected so that the stub acts as a notch filter at a second rejection wavelength λ₂, and n and m are different integers.

### FIELD OF THE INVENTION

The invention relates to an N-port signal divider/combiner for dividing and/or combining signals in N−1 frequency bands. The divider/combiner is used typically, but not exclusively, in a multiband antenna such as a Global Positioning System (GPS) antenna.

### BACKGROUND OF THE INVENTION

A conventional GPS signal divider/combiner is shown in U.S. Pat. No. 6,515,557 B1. The divider/combiner has a common line; and two signal ports each coupled to the common line by a respective transmission line. Each transmission line has an open-circuit stub extending from the transmission line, each stub having a length selected so that the stub acts as a notch filter at a respective rejection wavelength. In an alternate embodiment, the stubs may be short-circuit stubs.

U.S. Pat. No. 6,307,525 B1 describes an alternative planar transmission line diplexer or multiplexer, which employs open-circuit tuning stub elements.

### BRIEF DESCRIPTION OF EXEMPLARY EMBODIMENT

A first aspect of the exemplary embodiment provides an N-port signal divider/combiner for dividing and/or combining signals in N−1 frequency bands, including a common line; and N−1 signal ports each coupled to the common line by a respective transmission line, each transmission line having N−2 stubs extending from the transmission line, each stub having a length selected so that the stub acts as a notch filter at a respective rejection wavelength, wherein at least one of the stubs is a short-circuit stub, and at least one of the stubs is an open-circuit stub.

A second aspect of the exemplary embodiment provides an N-port signal divider/combiner for dividing and/or combining signals in N−1 frequency bands, including a common line; and N−1 signal ports each coupled to the common line by a respective transmission line, each transmission line having one or more stubs extending from the transmission line, wherein a first one of the stubs has a length nλ₁/4 selected so that the stub acts as a notch filter with a reject band including a first wavelength λ₁, a second one of the stubs has a length mλ₂/4 selected so that the stub acts as a notch filter with a reject band including a second wavelength λ₂, and wherein n and m are different integers.

We have recognized that the length of the stubs can be varied so as to achieve a desired frequency response. This can be achieved by making some stubs closed-circuit, and other stubs open-circuit. Alternatively, the length of the stubs may be varied by selecting appropriate different values for n and m. In this case, the stubs may all be open-circuit, or may all be closed-circuit, but at least two of the stubs will have different values selected for n and m.

### BRIEF DESCRIPTION OF THE DRAWINGS

The accompanying drawings which are incorporated in and constitute part of the specification, illustrate embodiments of the invention and, together with the general description of the invention given above, and the detailed description of the embodiments given below, serve to explain the principles of the invention.

FIG. 1 is a schematic view of a diplexer according to the invention;

FIG. 2 is a planar view of a quadrifilar helix antenna incorporating a combiner/divider according to the invention;

FIG. 3 is a detailed view of a feed circuit;

FIG. 4 is a schematic view of an amplifier incorporating two combiner/dividers according to the invention;

FIG. 5 is a graph showing the input return loss of the diplexer of FIG. 1;

FIG. 6 is a graph showing the output return loss of the diplexer of FIG. 1;

FIG. 7 is a graph showing the reject bands of the diplexer of FIG. 1; and

FIGS. 8-19 are graphs showing input and output return losses for a variety of different stub lengths.

### DETAILED DESCRIPTION OF EMBODIMENTS OF THE INVENTION

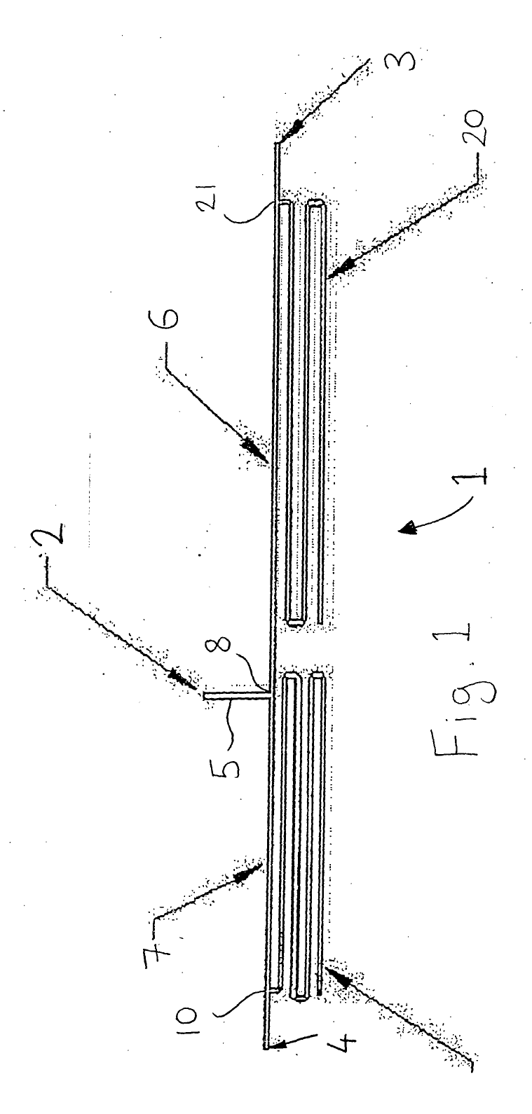

Referring to FIG. 1, diplexer 1 has an input/output port 2, L1 pass port 3 and L2 pass port 4. The ports 2-4 are connected via respective microstrip transmission lines 5,6,7 which meet at a junction 8.

A stub 9 meets the line 7 transversely at a junction 10. The stub 9 is short-circuited—that is, its end is in conductive contact with a ground plane (not shown) via a suitable ground connector (also not shown). The length of short-circuit stub 9 is approximately equal to λ(L1), where λ(L1) is the wavelength of GPS frequency L1. The distance along line 7 between junctions 8 and 10 is approximately equal to λ(L1)/4, accurate to within a few percent.

A stub 20 meets the line 6 transversely at a junction 21. The stub 20 is open-circuited—that is, its end is separated from the ground plane (not shown) by an insulator. The length of open-circuit stub 20 is approximately equal to ¾λ(L2) where λ(L2) is the wavelength of GPS frequency L2. The distance along line 6 between junctions 8 and 21 is approximately equal to λ(L2)/4.

The L1 pass port 3 is coupled, in use, to a quadrifilar L1 antenna (not shown) which is resonant in the L1 frequency band. The L2 pass port 4 is coupled, in use, to a quadrifilar L2 antenna (not shown) which is resonant in the L2 frequency band.

The L1 pass port 3 receives signals from the L1 antenna in the L1 frequency band. Signals at the L1 frequency pass along short-circuit stub 9, are reflected at the end of the short-circuit stub 9 with a 180° phase change, and return to junction 10 where they interfere destructively with the incoming energy at the L1 frequency. Thus the short-circuit stub 9 acts as a notch filter centred at the L1 frequency. As a result, L1 energy from port 3 is blocked from line 7 and passes along common line 5.

The L2 pass port 4 receives signals from the L2 antenna in the L2 frequency band. Signals at the L2 frequency pass along open-circuit stub 20, are reflected at the end of the stub 9 with no phase change, and return to junction 21 where they interfere destructively with the incoming energy at the L2 frequency. Thus the open-circuit stub 20 acts as a notch filter centred at the L2 frequency. As a result, L2 energy from port 4 is blocked from line 6 and is combined with the L1 energy on common line 5.

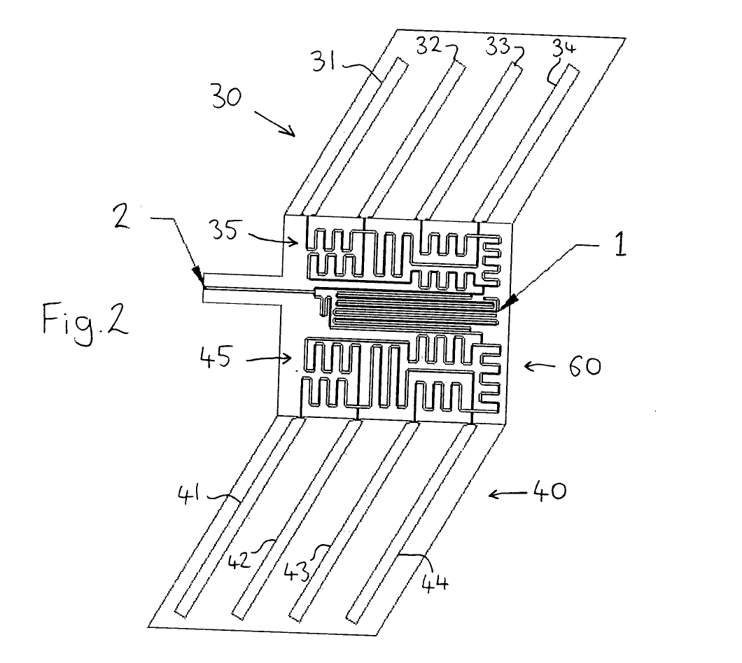

FIG. 2 is a planar view of a quadrifilar helix antenna incorporating the diplexer 1. The antenna is made of two radiating segments 30,40, and a base segment 60. The radiating segments 30,40 include radiating elements 31-34 and 41-44 respectively. The base segment 50 contains a pair of microstrip hybrid junction power divider feed circuits 35,45 on one side and a ground plane (not shown) on the opposite side. Segments 30,40,60 are made of one single section of dielectric substrate on which copper (or any suitable conductor) is deposited or etched to form the radiating elements, the diplexer, the hybrid junction power divider feed circuits, and the ground plane.

As is illustrated in FIG. 2, the radiating elements are each connected to a respective hybrid junction power divider feed circuit at one end and are open circuited at the other end. The length of each of the four radiating elements is initially ¼ wavelength. However, after tuning and compensation for end effects, the resulting length is shorter than ¼ wavelength. Nevertheless, the elements operate in ¼ wavelength mode.

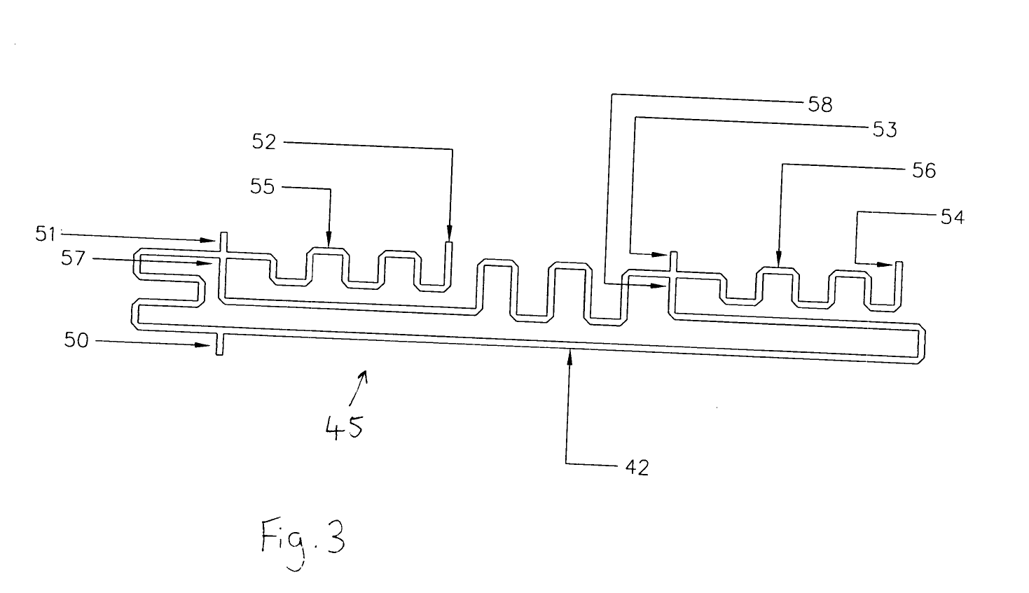

FIG. 3 shows one of the feed circuits 45 in more detail. The other feed circuit 35 is similar in construction. The hybrid coupler has a feed port 50 (coupled to the port 4 of the diplexer 1), 0° hybrid port 57 and −180° hybrid port 58. A 0° antenna port 51 is coupled directly to the 0° hybrid port 57. A −90° antenna port 52 is coupled to the 0° hybrid port via a 90° phased line 55. Similarly, a −180° antenna port 54 is coupled directly to the 180° hybrid port 58, and a −270° antenna port 53 is coupled to the 0° hybrid port via a 90° phased line 56. The radiating elements 41-44 are contiguous with the antenna ports 54,53,52,51 respectively. Thus the radiating elements are driven in phase quadrature, providing the phase relationships required by circularly polarized beam patterns.

The helical pattern is accomplished by designing the segments 30,40 as parallelograms having vertical sides set at a predetermined angle (e.g., 50 degrees) above the horizontal line of the rectangularly shaped segment 60. The radiating elements are then disposed at the same angle. Thus, once the antenna is turned into a cylinder such that the angled sides of the parallelogram as well as the two vertical sides of the segment 60 touch each other to form a seam, the radiating elements produce a helical pattern relative to each other. Note that the helical pattern is controlled by the pitch of the chosen angle. Hence, the more acute the angle, the more turns there will be in the helices formed by the radiating elements upon the cylindrical transformation of the planar antenna of FIG. 2.

The back of segment 60 is covered in copper which forms a ground plane (not shown) which is not electrically connected to the radiating elements. Hence, the antenna is open circuited. The back of sections 30,40 are devoid of copper.

The ground connection of short-circuit stub 9 is formed as a plated-through hole extending through to the ground plane on the back of segment 60. In an alternative construction, the ground connection may be made by bringing the stub 9 out to the side of the segment 60, and forming the connection round the side of the segment 60.

To fabricate the quadrifilar helix antenna, the planar antenna of FIG. 2 is bent inwardly into a cylinder. The hybrid junction power divider feed circuits, diplexer and radiating elements are located within the cylinder whereas the ground plane is outside. This is done to protect the antenna from possible damage due to handling and thereby eliminating the need to later run performance tests. Thus, in an alternative embodiment, the planar antenna of FIG. 2 may be bent outwardly.

To manufacture the antenna of the present invention, the hybrid junction power divider feed circuits 35,45 have to first be designed to provide impedance matching and 0 to 180° phase shift while fitting into a particular chosen area. Secondly, the 0° and 180° phase shift locations of the hybrid junction power divider feed circuits 35,45 have to be located. Thirdly, the correct length and impedance of the 90° phased lines 53,56 must be established to allow for both n/4 wavelength mode of operation and phase quadrature between the antenna ports. Once the steps above are accomplished, the correct configuration of all pertinent parts of the antenna is simply etched or deposited onto a dielectric substrate. The dielectric substrate can be made of glass, fiberglass, Teflon or any other material or combination thereof. However, in this case a pliable dielectric substrate is used to facilitate the shaping of the planar antenna of FIG. 2 into a cylinder.

Once the deposition or etching of the copper on the dielectric substrate is completed, the antenna is bent into a cylinder. The antenna is then fastened in that shape by taping the edges of the upper section of the antenna together and by soldering or joining the edges of the ground plane with conductive tape. Finally, a connector is soldered to the end of the input/output port 2.

Note that with this method, many antennas can be deposited or etched on a large section of dielectric substrate. After the deposition, each antenna can be die cut, rolled into a cylinder, soldered or joined at the right locations and be ready for use. Note also that the soldering is minimal (i.e., one or two soldering connections) and done on non-sensitive parts of the antenna (i.e., ground plane and connector).

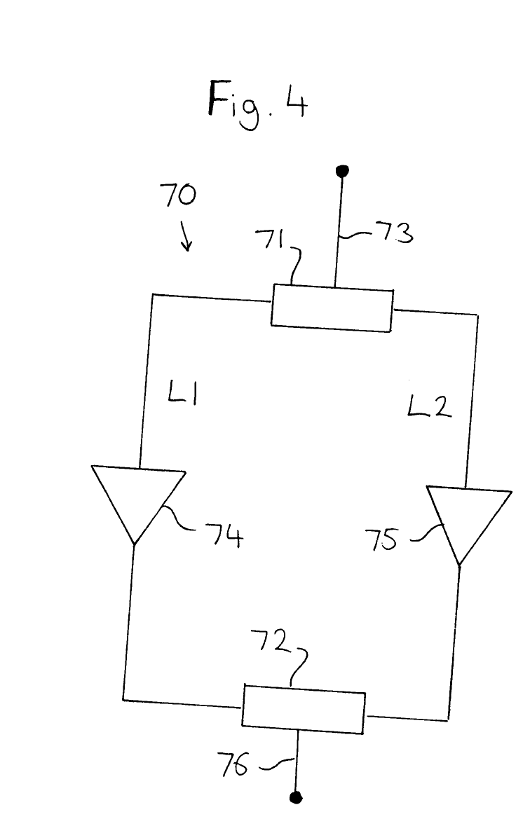

Although the diplexer of FIG. 1 is shown in FIGS. 2 and 3 in use in a quadrifilar antenna, the diplexer may also be used in an amplifier as shown in FIG. 4. FIG. 4 shows an amplifier 70 incorporating a signal divider 71 and a signal combiner 72. The dividers 71 and 72 are each constructed in the same manner as the diplexer 1 of FIG. 1. Divider 71 receives signals in the L1 and L2 frequency bands on common input line 73, directs the L1 signals to amplifier 74, and directs the L2 signals to amplifier 75. After amplification, the L1 and L2 signals are combined by combiner 72 and output on common line 76.

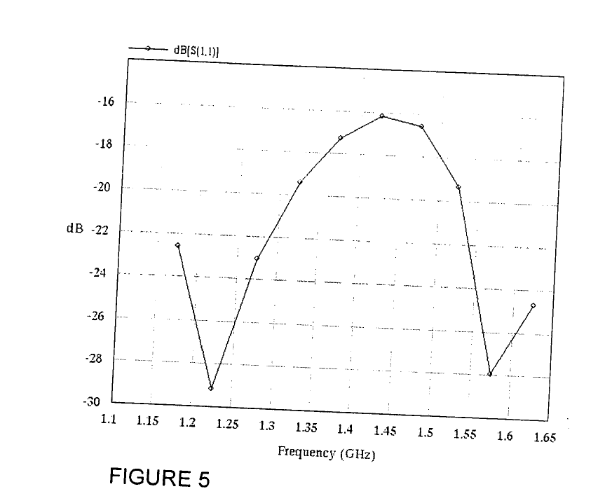

The performance of the diplexer 1 will now be described with reference to FIGS. 5-7.

FIG. 5 shows the input port return loss dB[S(1,1)] of the diplexer 1. Specifically, FIG. 5 shows the ratio between the power input to port 2 and the power reflected back to port 2 from the diplexer, over a range of frequencies from 1.175 GHz to 1.625 GHz. It can be seen that the input return loss has minima at 1.2276 GHz (the L2 frequency) and 1.57542 GHz (the L1 frequency), and a single maximum approximately mid-way between the L1 and L2 frequencies.

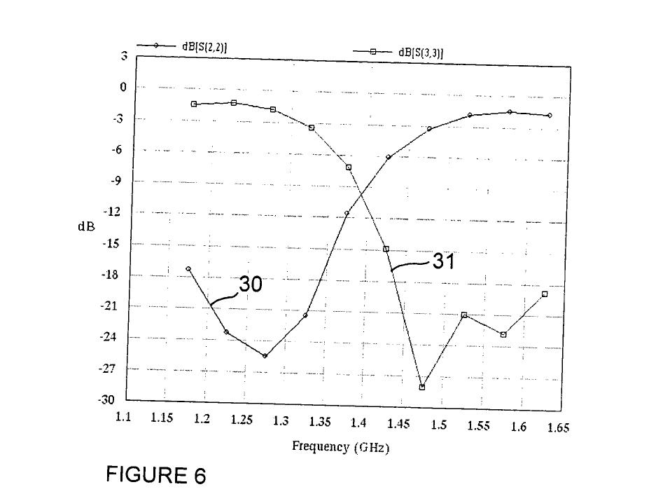

FIG. 6 shows the output port return loss of the diplexer. Plot 30 shows the output port return loss dB[S(3,3)] for L2 pass port 4, and plot 31 shows the output port return loss dB[S(2,2)} for L1 pass port 3. Specifically, plot 30 shows the ratio between the power input to port 4 and the power reflected back to port 4 from the diplexer, over a range of frequencies from 1.175 GHz to 1.625 GHz. It can be seen that the plot 30 has a single minimum at the L2 frequency. Similarly, plot 31 shows the ratio between the power input to port 3 and the power reflected back to port 3 from the diplexer. It can be seen that the plot 31 has minima at the L1 frequency, and at 1.475 GHz.

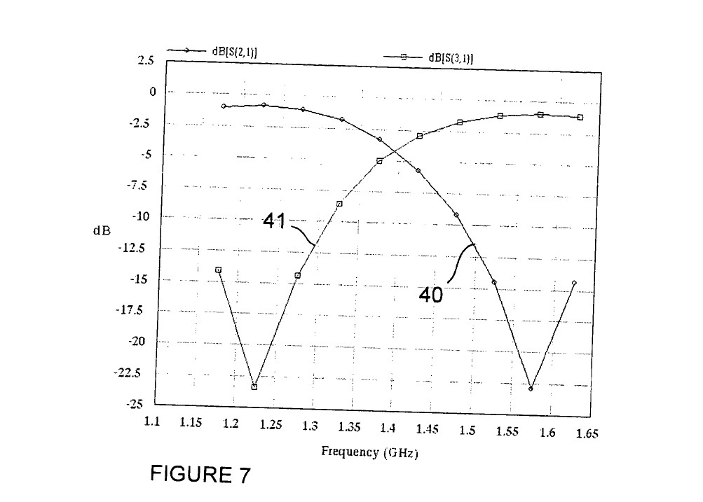

FIG. 7 shows the reject bands of the diplexer. Specifically, plot 40 shows the ratio dB[S(2,1)] between the power input to L2 pass port 4 and the power output from input/output port 2, over a range of frequencies from 1.175 GHz to 1.625 GHz. It can be seen that the plot 40 has a single minimum at the L1 frequency, and approaches 0 dB at the L2 frequency. Similarly, plot 41 shows the ratio dB[S(3,1)] between the power input to L1 pass port 3 and the power output from input/output port 2. It can be seen that the plot 41 has a single minimum at the L2 frequency, and approaches 0 dB at the L1 frequency.

Although in the embodiment of FIG. 1, the open-circuit stub 20 has a length of ¾λ(L2), the stub 20 can have any length nλ(L2)/4, where n is an odd integer 1,3,5 etc. Similarly, although the length of short-circuit stub 9 is (L1), the short-circuit stub 9 can have any length mλ(L1)/4, where m is an even integer 2,4,6 etc. However, it has been found that selecting n=3 and m=4 provides optimal performance in the L1 and L2 bands.

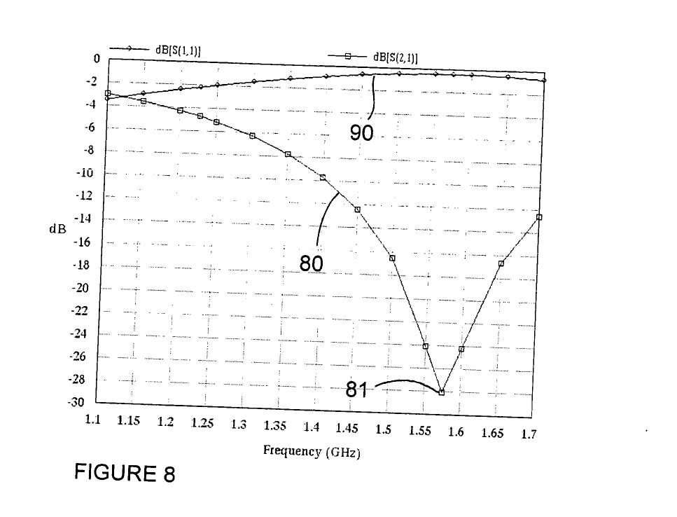

The values n=3 and m=4 were selected by comparing the performance of stubs of various lengths, as illustrated in FIGS. 8 to 19. FIGS. 8-19 each show the input port return loss dB[S(1,1)] and output port return loss dB[S(2,1)] of a two-port notch filter incorporating a stub with a respective different length.

Specifically, the stub lengths and configurations are as shown below:

FIG. 8: L1 reject, 90° open-circuit

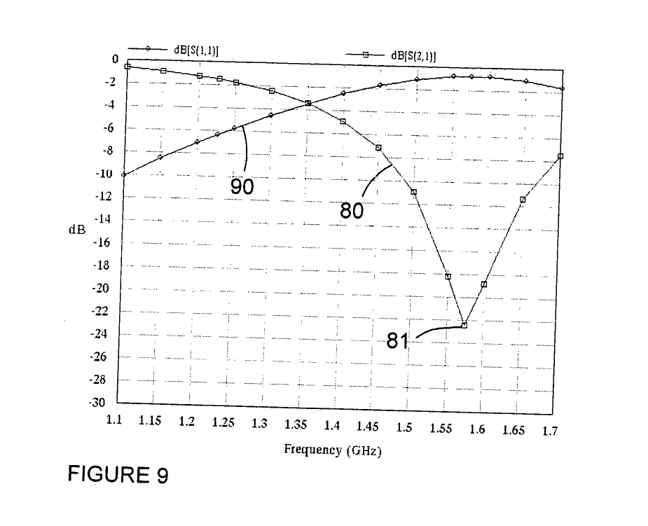

FIG. 9: L1 reject, 180° short-circuit

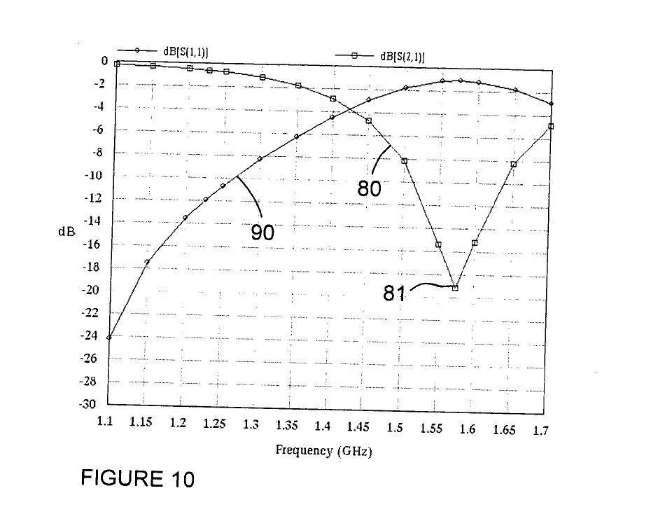

FIG. 10: L1 reject, 270° open-circuit

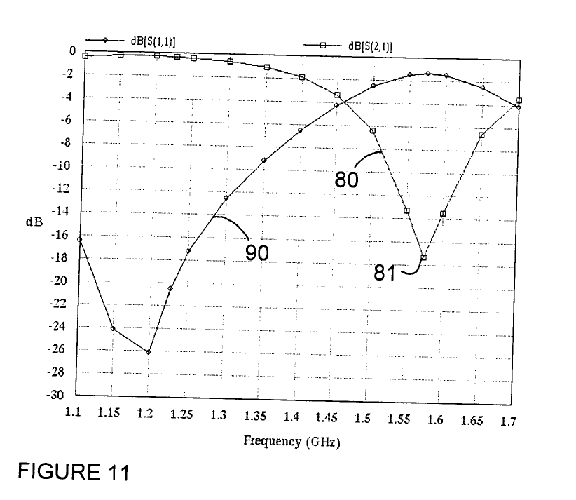

FIG. 11: L1 reject, 360° short-circuit

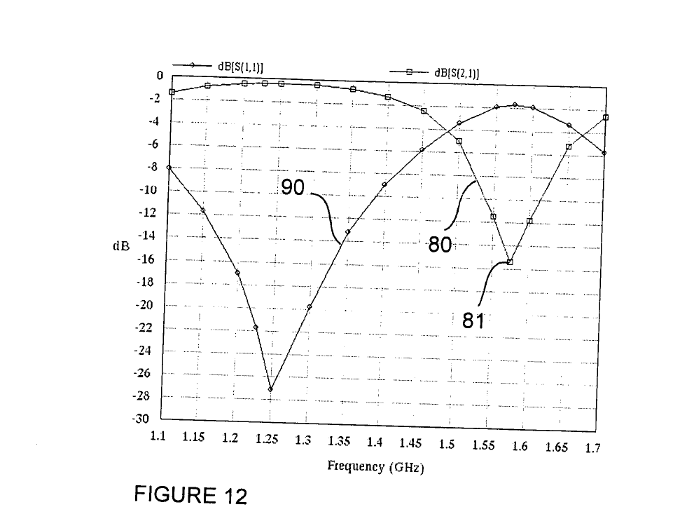

FIG. 12: L1 reject, 450° open-circuit

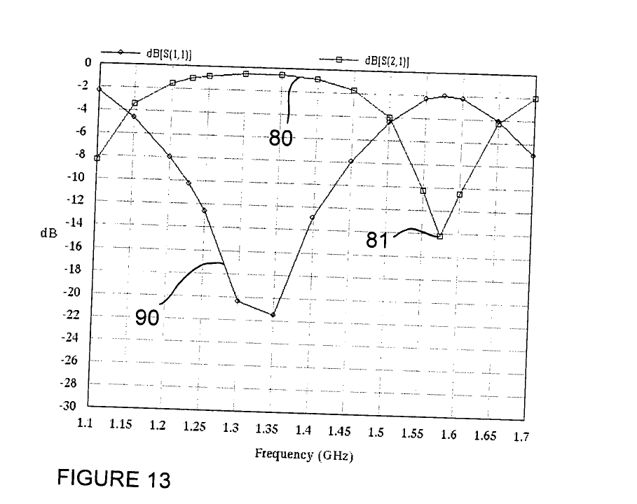

FIG. 13: L1 reject, 540° open-circuit

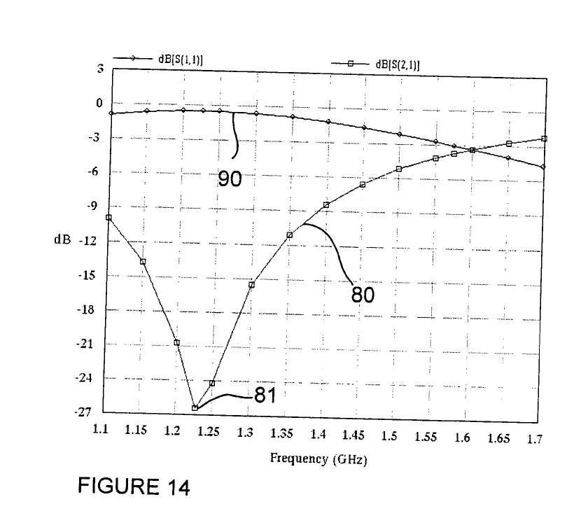

FIG. 14: L2 reject, 90° open-circuit

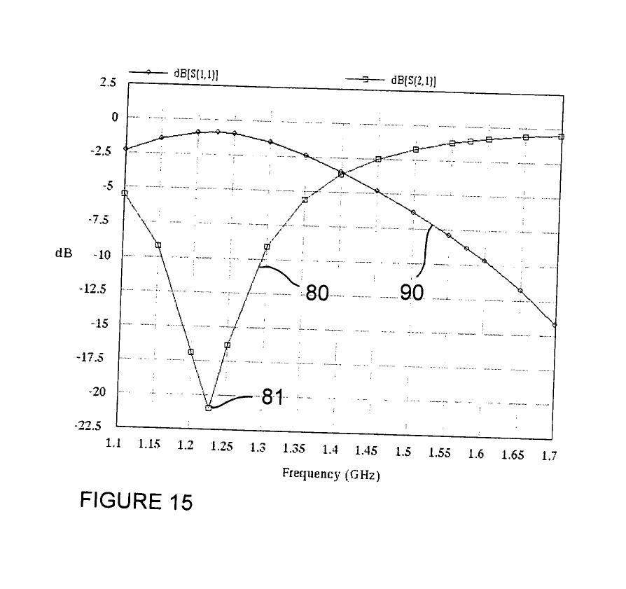

FIG. 15: L2 reject, 180° short-circuit

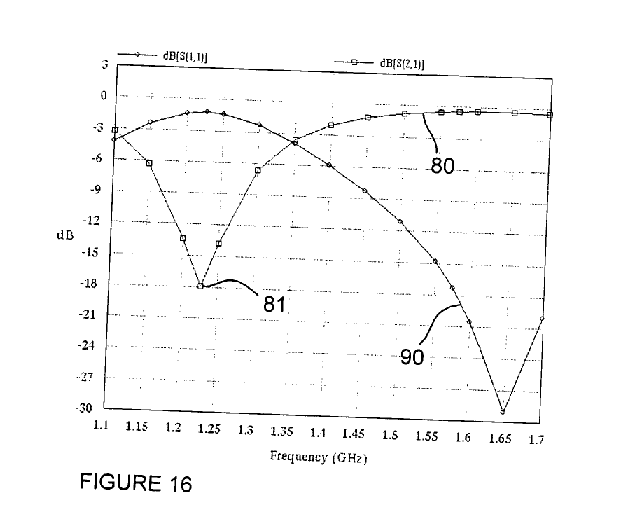

FIG. 16: L2 reject, 270° open-circuit

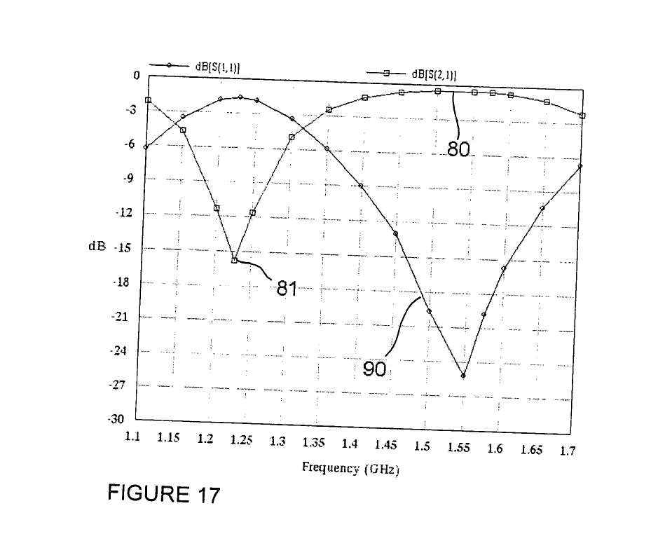

FIG. 17: L2 reject, 360° short-circuit

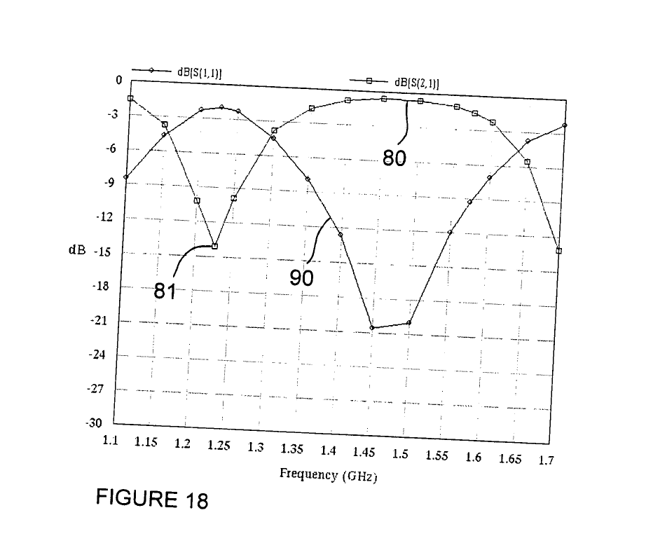

FIG. 18: L2 reject, 450° open-circuit

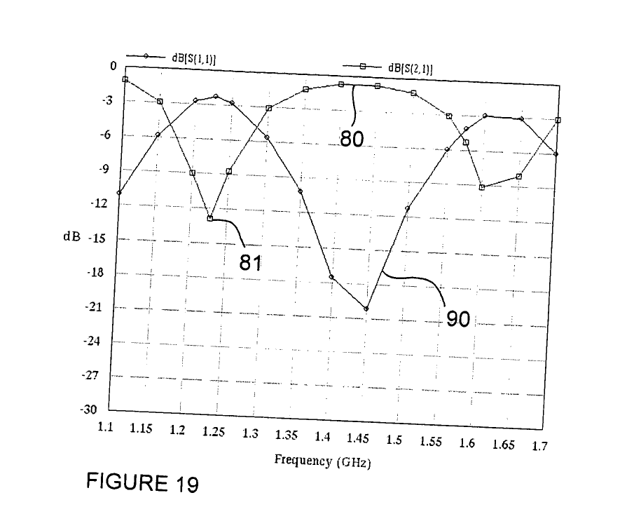

FIG. 19: L2 reject, 540° open-circuit

The input port return loss dB[S(1,1)] is labelled 90 in FIGS. 8-19, and the output port return loss dB[S(2,1)] is labelled 80 in FIGS. 8-19. The output port return loss labelled 80 has a minimum labelled 81 at either the L1 frequency (for the L1 reject FIGS. 8-13), or at the L2 frequency (for the L2 reject FIGS. 14-19).

Optimal operation is achieved by selecting a length of stub which gives a relatively low input return loss 80 and a relatively high output return loss 90 at the reject frequency; whilst also having a relatively high input return loss 80 and a relatively low output return loss 90 at the pass frequency.

We have selected the stub lengths corresponding with FIG. 11 and FIG. 16. For these stub lengths, the loss figures are approximately as follows:

FIG. 11: L1 reject, 360° short-circuit:

input return loss 80 at L1: −17.5 dB

output return loss 90 at L1: −1.5 dB

input return loss 80 at L2: −0.5 dB

output return loss 90 at L2: −20.5 dB

FIG. 16: L2 reject, 270° open-circuit:

input return loss 80 at L2: −18 dB

output return loss 90 at L2: −1.5 dB

input return loss 80 at L1: −0.5 dB

output return loss 90 at L1: −17 dB

It can be seen from FIGS. 8-19 that other stub lengths could be selected, but may be less optimal than the selected stub lengths.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

Although the preferred embodiment is operated in receive mode for receiving satellite GPS signals, the antenna could also be operated in transmit mode for other applications. The antenna could also be operated in both transmit and receive mode, either simultaneously or alternately.

The principle of the diplexer can be extended to an N-port divider/combiner with a common line, N−1 transmission lines coupled to the common line, each transmission line having N−2 stubs.

1. An N-port signal divider/combiner for dividing and/or combining signals in N−1 frequency bands, including a common line; and N−1 signal ports each coupled to the common line by a respective transmission line, each transmission line having one or more stubs extending from the transmission line, each stub having a length selected so that the stub acts as a notch filter at a respective rejection wavelength, wherein at least one of the stubs is a short-circuit stub, and at least one of the stubs is an open-circuit stub.

2. A signal divider/combiner according to claim 1 wherein the distance between the common line and each stub is approximately λ/4, where λ is the rejection wavelength of the stub.

3. A signal divider/combiner according to claim 1 wherein the common line and transmission lines are formed in a microstrip configuration.

4. A signal divider/combiner according to claim 1 wherein the signal divider/combiner is a diplexer in which N=3.

5. A signal divider/combiner according to claim 1 wherein one of the rejection wavelengths is a Global Positioning System L1 frequency, and one of the rejection wavelengths is a Global Positioning System L2 frequency.

6. A multiband antenna including N−1 antennas each dimensioned to transmit and/or receive radiation in a respective frequency band, and an N-port signal divider/combiner according to claim 1, wherein each antenna is coupled to a respective transmission line of the N-port signal divider/combiner.

7. An amplifier including one or more N-port signal divider/combiners according to claim 1.

8. An N-port signal divider/combiner for dividing and/or combining signals in N−1 frequency bands, including a common line; and N−1 signal ports each coupled to the common line by a respective transmission line, each transmission line having one or more stubs extending from the transmission line, wherein a first one of the stubs has a length nλ₁/4 selected so that the stub acts as a notch filter with a reject band including a first wavelength λ₁, a second one of the stubs has a length mλ₂/4 selected so that the stub acts as a notch filter with a reject band including a second wavelength λ₂, and wherein n and m are different integers.

9. A signal divider/combiner according to claim 8 wherein the first one of the stubs is an open-circuit stub, the second one of the stubs is a closed-circuit stub, n is an odd integer, and m is an even integer.

10. A signal divider/combiner according to claim 8 wherein the first one of the stubs is an open-circuit stub with a length 3λ₁/4, and the second one of the stubs is a closed-circuit stub with a length λ₂.

11. A signal divider/combiner according to claim 8 wherein the distance between the common line and each stub is approximately λᵢ/4, where λᵢ is the wavelength in the reject band of the notch filter formed by the stub.

12. A signal divider/combiner according to claim 8 wherein the common line and transmission lines are formed in a microstrip configuration.

13. A signal divider/combiner according to claim 8 wherein the signal divider/combiner is a diplexer in which N=3.

14. A signal divider/combiner according to claim 8 wherein one of the rejection wavelengths is a Global Positioning System L1 frequency, and one of the rejection wavelengths is a Global Positioning System L2 frequency.

15. A multiband antenna including a first antenna dimensioned to transmit and/or receive radiation at a first wavelength λ₁, a second antenna dimensioned to transmit and/or receive radiation at a second wavelength λ₂, and a signal divider/combiner including a common line; first and second transmission lines coupling the first and second antennas respectively to the common line; a first stub extending from the first transmission line and having a length nλ₂/4 selected so that the stub acts as a notch filter with a reject band including the second wavelength λ₂; and a second stub extending from the second transmission line and having a length nλ₁/4 selected so that the stub acts as a notch filter with a reject band including the first wavelength λ₁, wherein n and m are different integers.

16. An amplifier including one or more N-port signal divider/combiners according to claim 8.

17. A method of operating an N-port signal divider/combiner according to claim 8, the method including rejecting signals at the first wavelength λ₁ with the first stub; and rejecting signals at the second wavelength λ₂ with the second stub.
